(19) United States
(12) Patent Application Publication
(10) Pub. No.: US 2026/0200100 A1
(43) Pub. Date: Jul. 16, 2026

(54) MECHANICAL HAND AND ROBOT

(71) Applicants: ZHEJIANG QIANGNAO TECHNOLOGY CO., LTD., HANGZHOU (CN); SHENZHEN MENTAL FLOW TECHNOLOGY CO.,LTD., SHENZHEN (CN)

(72) Inventors: BICHENG HAN, HANGZHOU (CN); WENGUANG WANG, HANGZHOU (CN); DISI A, HANGZHOU (CN); ZHAN LU, HANGZHOU (CN); YIQIAN GAO, HANGZHOU (CN); JUNHAN LI, HANGZHOU (CN)

(21) Appl. No.: 19/375,297

(22) Filed: Oct. 31, 2025

(30) Foreign Application Priority Data
Jan. 16, 2025 (CN) 202510066503.7

(51) Int. Cl. B25J 15/00

(52) U.S. Cl. CPC B25J 15/0009

(57) ABSTRACT

The disclosure provides a mechanical hand and a robot. The mechanical hand includes a palm base; and a plurality of finger assemblies, each of which includes a base, knuckles mounted on the base, and a driver for driving the knuckles to rotate relative to the base. The palm base is provided with a mounting groove, the mounting groove is provided with a opening communicated with outside, and an end of the mounting groove away from the opening is provided with a mounting position; the driver enters the mounting position through the opening, and the base is at least partially accommodated in the mounting groove, a side of the mounting groove close to the opening is formed with an arc-shaped end face gradually tapered from inside to outside. The mechanical hand further includes a connecting assembly for fixing the base in the mounting groove.

### TECHNICAL FIELD

The disclosure relates to the technical field of mechanical hands, in particular to a mechanical hand and a robot.

### BACKGROUND

Driven by continuous technological advancements, mechanical hand technology is playing an increasingly important role in many fields, such as industrial automation, medical rehabilitation assistance, space exploration, and operations in hazardous environments . With increasing diversity and complexity of application scenarios, performance requirements for the mechanical hands are also constantly improved.

In related art, assembly structure between fingers and palm of mechanical hand is complicated. During prolonged use and impact of the mechanical hand, not only parts connecting multiple fingers exhibit poor stability, but also the fingers are prone to loosening and displacement, and are prone to occur wear which may result in fractures. These problems seriously compromise operation accuracy and reliability of the mechanical fingers. There remains substantial room for improvement in this aspect of the mechanical hand. Therefore, it is urgent for technicians in this art to improve stability of assembly between the palm and mechanical fingers.

### SUMMARY

A mechanical hand and a robot are provided in the disclosure, aiming to address the issue of poor stability in the connection part between a finger and a palm of an mechanical hand in related art.

In order to achieve the above object, a mechanical hand is provided in the disclosure, which includes:

a palm base; and

a plurality of finger assemblies, each of the finger assemblies includes a base, knuckles mounted on the base, and a driver for driving the knuckles to rotate relative to the base, one end of the driver being fixed on the base and the other end of the driver extending away from the knuckles.

The palm base is defined with a mounting groove, the mounting groove has an opening communicated with outside, and an end of the mounting groove away from the opening is provided with a mounting position. The driver enters the mounting position through the opening, and the base is at least partially accommodated in the mounting groove. A side of the mounting groove close to the opening is formed with an arc-shaped end face gradually tapered from inside to outside for limiting a horizontal movement range of the base.

The mechanical hand further includes a connecting assembly for fixing the base in the mounting groove.

In some embodiments, the mounting groove is a U-shaped groove, the arc-shaped end face is a U-shaped end face, and both ends of the arc-shaped end face are further formed with extension parts extending towards the knuckles.

In some embodiments, the mechanical hand further includes a palm-side housing and a back-side housing respectively covering inner and outer sides of the palm base. An upper cavity is defined between the back-side housing and the palm base, a lower cavity is defined between the palm-side housing and the palm base, and a through hole communicating the upper cavity with the lower cavity is defined in the mounting position. The driver is located in the upper cavity, and the driver is obliquely arranged towards the lower cavity via the through hole.

In some embodiments, a clamping part is provided at an end of the back-side housing close to the opening, the base is defined with a groove adapted to the clamping part, a clamping block is formed on the clamping part and extends towards the groove, and a clamping slot matched with the clamping block is provided in the groove.

In some embodiments, a partition plate is provided between two adjacent mounting positions, a protrusion is extending transversely is provided on the partition plate, and a hooking part matched with the protrusion is provided on the back-side housing. The back-side housing is provided with a support bar towards the palm base and abutted against an outer side wall of the driver.

In some embodiments, the base is further provided with two limiting end faces abutted against the two extension parts, and the two limiting end faces are arranged at two ends of the groove.

In some embodiments, a protruding part is provided at an end of the base away from the knuckles, and a concave slot matched with the protruding part is defined in the mounting groove, and a mounting hole penetrating through the mounting groove and communicated with the outside is provided in the concave slot.

The connecting assembly includes a fastener, and the fastener passes through the mounting hole and penetrates through the protruding part.

In some embodiments, a limiting part is formed in the mounting groove along an assembly direction of the base, and the base is provided with a first stop part capable of abutting against the limiting part.

In some embodiments, the base is further provided with a second stop part capable of abutting against an outer side wall of the palm base. The first stop part and the second stop part are sequentially arranged along the assembly direction of the base, and sections of the first stop part and the second stop part along the assembly direction of the base are stepped. When assembled in place, the first stop part is located in the mounting groove, and the second stop part is located outside the mounting groove.

Further, a robot is further provided in the disclosure, which includes a robot body and the mechanical hand described above. The mechanical hand is arranged on the robot body.

The beneficial effects of the present disclosure are as follows. The finger assembly of the disclosure is installed on the palm base, during assembly, a side of the finger assembly provided with the driver is inserted into the opening, and the driver enters the mounting position in the mounting groove, indicating proper installation. At this point, the base is received in the mounting groove, and the arc-shaped end surface at the opening, which gradually tapers from inward to outside, closely fits the outer wall of the base, with its tapered two ends serving to restrict the movement range of the base. The base is then fixed in the mounting groove by using the connecting assembly, completing installation of the finger assembly. The present disclosure achieves firm fixation of the base in the mounting groove, making it more stable during operation and reducing unnecessary shaking or displacement. The mounting groove can effectively transfer external forces acting on the base from various directions to the palm base. When the finger assembly is subjected to external forces, the external force can be uniformly dispersed to the palm base instead of concentrated on localized areas of the finger assembly, thus improving load-bearing capacity of the finger assembly, improving stability of the connection between the finger assembly and the palm base, and prolonging service life of the mechanical hand.

### BRIEF DESCRIPTION OF THE DRAWINGS

FIG. 1 is a schematic view of an overall structure of a mechanical hand according to an embodiment of the disclosure;

FIG. 2 is a schematic exploded view of a mechanical hand according to an embodiment of the disclosure;

FIG. 3 is a schematic cross-sectional view of a connection between a palm base and a finger assembly of a mechanical hand according to an embodiment of the disclosure;

FIG. 4 is a schematic structural view of a palm base of a mechanical hand according to an embodiment of the disclosure;

FIG. 5 is a schematic structural view of a finger assembly of a mechanical hand according to an embodiment of the disclosure;

FIG. 6 is a schematic structural view of a base of a mechanical hand according to an embodiment of the disclosure;

FIG. 7 is a schematic structural view of a back-side housing of a mechanical hand according to an embodiment of the disclosure;

FIG. 8 is a sectional view of a mechanical hand according to an embodiment of the disclosure; and

FIG. 9 is a schematic view of an overall structure of a robot according to an embodiment of the disclosure.

Reference numbers in the figures are as follows: 100. Mechanical Hand; 1. palm base; 11. Mounting Groove; 111. opening; 112. Arc-shaped End Face; 113. Through Hole; 114. Concave Slot; 1141. Mounting Hole; 115. Limiting Part; 12. Extension Part; 13. Partition Plate; 131. protrusion; 2. Finger Assembly; 21. Base; 211. Groove; 2111. Clamping Slot; 212. Limiting End Face; 213. Protruding Part; 214. First Stop Part; 215. Second Stop Part; 22. knuckle; 23. Driver; 3. Thumb Module; 31. Mounting Plate; 32. interdigital fold sleeve; 4. palm-side housing; 5. back-side housing; 51. Clamping Part; 511. Clamping Block; 52. Hooking Part; 53. Support Bar; 6. Fastener; 7. Mounting Position; 8. Connecting Assembly; 9. Upper Cavity; 10. Lower Cavity; 200. Robot; 201. Robot Body.

### DETAILED DESCRIPTION OF THE EMBODIMENTS

In the following, the scheme in the embodiment of the disclosure will be described clearly and completely in connection with the drawings. Obviously, the described embodiment is intended to be only a part of the embodiments of the disclosure, but not all of them. On a basis of the embodiments in this disclosure, all other embodiments obtained by the ordinary skilled in the art without any creative effort are within the protection scope of this disclosure.

It should be noted that all of directional indications (such as up, down, left, right, front, back, etc.) in the embodiments of the disclosure are only used to illustrate relative position relationships and movement conditions among respective components in a certain posture (as shown). If the certain posture changes, the directional indications vary accordingly.

It should also be noted that when an element is referred to be “fixed” or “provided” on another element, it may be directly on the another element or an intervening element may exist. When an element is referred to be “connected” to another element, it may be directly connected to the another element or an intervening element may exist.

In addition, descriptions involving “first”, “second” or the like in this disclosure are only intended for descriptive purposes, and cannot be understood as indicating or implying a relative importance, or implicitly indicating a number of indicated technical features. Therefore, the features defined with “first” and “second” can explicitly or implicitly include at least one of these features. In addition, technical schemes of respective embodiments can be combined with each other, which must be based on enabling of realization by an ordinary skilled in the art. When combination of technical schemes is contradictory or impossible to be realized, it should be considered that such combination of technical schemes does not exist and either is not within the protection scope claimed in this disclosure.

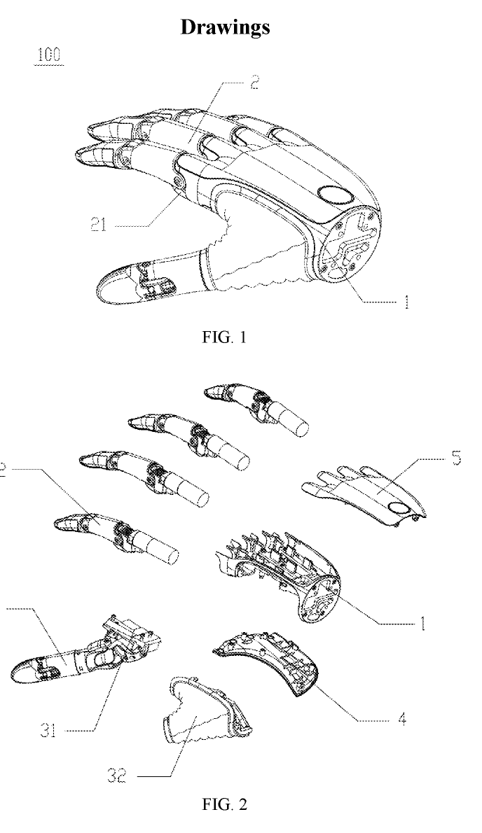

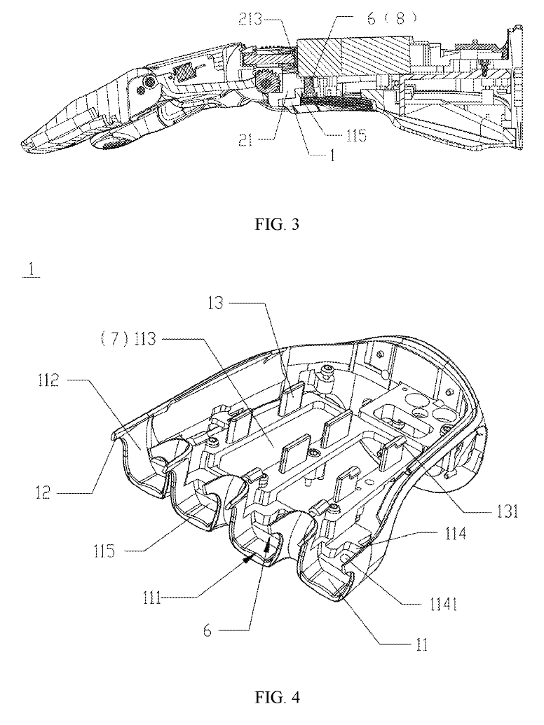

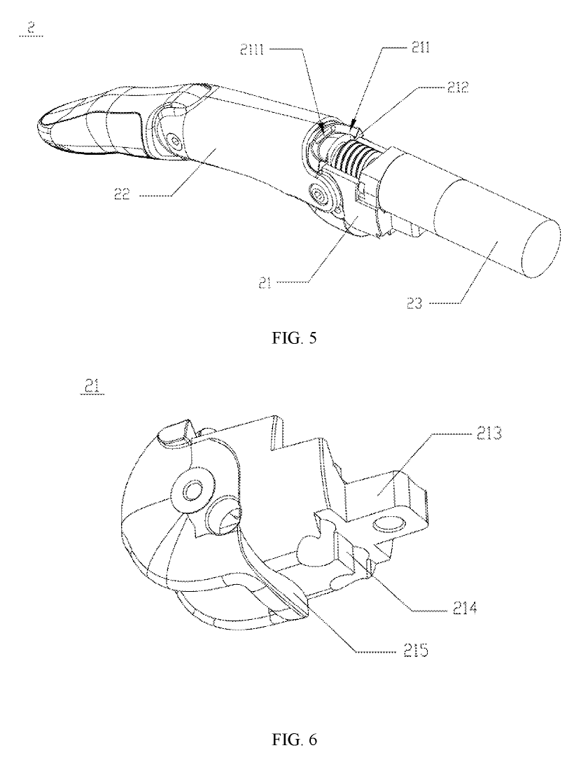

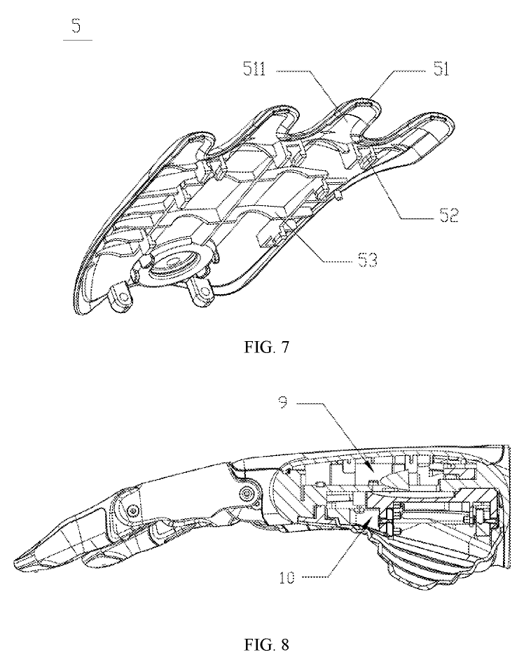

A mechanical hand 100 is provided in the present disclosure, which, referring to FIGS. 1 to 8, includes:

a palm base 1; and

a plurality of finger assemblies 2, each of which includes a base 21, knuckles 22 mounted on the base 21, and a driver 23 for driving the knuckles 22 to rotate relative to the base 21. One end of the driver 23 is fixed on the base 21 and the other end of the driver 22 extends away from the knuckles 22.

The palm base 1 is provided with a mounting groove 11, the mounting groove 11 is provided with a opening 111 communicated with outside, and an end of the mounting groove 11 away from the opening 111 is provided with a mounting position 7. The driver 23 enters the mounting position 7 through the opening 111, and the base 21 is at least partially accommodated in the mounting groove 11. A side of the mounting groove 11 close to the opening 111 is formed with an arc-shaped end face 112 gradually tapered from inside to outside for limiting a horizontal movement range of the base 21.

The mechanical hand 100 further includes a connecting assembly 8 for fixing the base 21 in the mounting groove 11.

In this embodiment, the driver 23 may take in various forms, such as a small motor, or a pneumatic or hydraulic device. These different types of drivers 23 may be selected according to specific application scenarios so as to meet operation requirements of the mechanical hand 100 under various working conditions.

The knuckles 22 are installed on the base 21, and are direct components to realize grasping and manipulating functions of the mechanical hand 100. The driver 23 drives the knuckles 22 to rotate relative to the base 21, and the knuckles 22 can simulate bending and stretching actions of fingers of a human hand, completing various complicated grasping and manipulating tasks. A number, shape, and moving range of the knuckles 22 may be selected according to specific application scenarios, adapting to grasping of objects with various shapes and sizes.

Referring to FIGS. 1 and 2, in this embodiment, there are four finger assemblies 2, including an index finger module, a middle finger module, a ring finger module, and a tail finger module arranged in sequence. The finger assemblies 2 are designed as mutually independent modules and detachably connected with a palm housing, which facilitates manufacturing and allows for convenient future improvement and adjustment. Finger housings can be flexibly configured according to different application scenarios. For example, in some tasks requiring precise operations, finger assemblies 2 with higher precision sensors can be provided. In scenarios demanding greater grasping force, heavy-duty finger assemblies 2 can be utilized instead. This improves versatility and adaptability of the mechanical hand 100. In addition, the palm housing is provided with a thumb module 3, which is mounted differently from the finger housing. The thumb module 3 is directly fixed on the palm housing through a mounting plate 31. Thumb plays a crucial role in balancing and assisting hand grasping, and though its independent fixation method and force applied from one side, the thumb can cooperate with other fingers more flexibly. This structure can better simulate hand grasping actions. The thumb module 3 is further provided with an interdigital fold sleeve 32 with certain degree of flexibility and elasticity, serving as a protective barrier for the internal components of the thumb module 3 and naturally extending and retracting along with the movement of the thumb module 3 without hindering movement of the thumb module 3. In addition, the inclusion of the interdigital fold sleeve 32 also makes the thumb module 3 visually resemble the real interdigital space of a human hand, greatly enhancing the overall realism of the mechanical hand 100’s appearance.

In this embodiment, the opening 111 of the mounting groove 11 is located at an edge of the palm base 1, allowing for an enough operation space for the finger assembly 2 to be mounted and dismounted. One end of the driver 23 is fixed on the base 21, and the other end of the driver 23 is arranged to extend away from the knuckle 22. The end of the mounting groove 11 away from the opening 111 is provided with a mounting position 7 for mounting the driver 23 entered through the mounting groove 11 of the palm base 1, hiding the driver 23 inside the palm base 1 and improving safety and stability of the driver 23. The mounting position 7 is set corresponding to the driver 23 to provide a special accommodation space for the driver 23. During operations of the mechanical hand 100, the driver 23 may be subjected to various influence such as vibration generated by its own operations, forces transmitted from movement of the finger assembly 2, and external environmental disturbances. The accommodating space provided by the mounting position 7 for the driver 23 effectively prevents displacement of the driver 23, allowing the driver 23 to maintain stability under various forces.

The base 21 is partially accommodated in the mounting groove 11, facilitating and ensuring precision during assembly of the mechanical hand 100, and allowing operators to position the base 21 by aligning it with the contour of the mounting groove 11. The combination of the base 21 and the mounting groove 11 enables the base 21 to to effectively transfer various forces, generated either by movement of the knuckles 22 or external operations, to the palm base 1 in a well-distributed manner.

The tapered contour of the arc-shaped end face 112, which narrows progressively from center towards both ends, serves to accurately limit a position of the base 21. In an assembly process of the mechanical hand 100, as the base 21 is inserted deeper into the mounting groove 11, the gradually tapered arc-shaped end face 112 can limit the base 21 within a specific range, ensuring that the base 21 of each finger assembly 2 can be in an accurate position after installation, thus improving the overall assembly accuracy of the mechanical hand 100.

A primary function of the connecting assembly 8 is to firmly fix the base 21 in the mounting groove 11, preventing the base 21 from displacing, shaking, or rotating in the mounting groove 11. The connecting assembly 8 evenly distributes and transfers force to the palm base 1, so as to avoid localized stress concentration that could lead to structural damage. This ensures that the finger assembly 2 consistently maintains in precise operation position.

Further, the mounting groove 11 is a U-shaped groove, the arc-shaped end face 112 is a U-shaped end face, and both ends of the arc-shaped end face 112 are further provided with extensions 12 extending towards the knuckles 22.

A side of the mounting groove 11 close to the opening 111, that is, the arc-shaped end face 112, is designed to be U-shaped to effectively limit the moving range of the finger assembly 2 in five degrees of freedom. When the finger assembly 2 is subjected to a horizontal external force, the U-shaped end face wraps the finger assembly 2, evenly distributing the force to the palm base 1, and thereby enhancing the stability of the finger assembly 2. For example, during grasping operation of the mechanical hand 100, object may generate horizontal friction or impact force on the finger assembly 2. These forces are transmitted through the U-shaped end face to the palm base 1, where they become effectively dispersed, avoiding localized stress concentration that could damage either the palm housing or the finger assembly 2.

In addition, the U-shaped groove also provides good guidance for installation of the finger assembly 2. During installation, operator can easily align the base 21 on the finger assembly 2 with the contour of the U-shaped groove and complete the insertion and installation, reducing the time required for groping and adjustment during the installation process. The design of the U-shaped groove also enables the operator to visually observe the insertion status of the finger assembly 2 from both sides of the opening 111. This visibility aids in promptly identifying issues during the installation process, such as whether the finger assembly 2 is level or if it interferes with other structures in the groove, thereby improving convenience of maintenance and inspection.

In addition to positional constraint provided by the arc-shaped end surface 112 itself on the base 21, the extension part 12 can also serve as an additional limiting function, limiting the base 21 in position from left and right sides to prevent the base 21 from slightly displacing or wobbling on a horizontal plane, thus effectively maintaining stability of the base 21’s position. The extension part 12 also plays a guiding role in installation of the base 21. During a process of placing the driver 23 of the finger assembly 2 into the mounting position 7 through the opening 111 and accommodating the base 21 in the mounting groove 11, the extension part 12 can assist the operator in positioning the base 21 more accurately. The shape of the extension part 12, which extends towards the knuckles 22, creates a guiding tendency, guiding the base 21 to enter the mounting groove 11 along an appropriate path.

Further, the mechanical hand 100 further includes a palm-side housing 4 and a back-side housing 5 which covers on inner and outer sides of the palm base 1. An upper cavity 9 is defined between the back-side housing 5 and the palm base 1, a lower cavity 10 is defined between the palm-side housing 4 and the palm base 1, and a through hole 113 communicating the upper cavity 9 with the lower cavity 10 is defined in the mounting position 7. The driver 23 is located in the upper cavity, and the driver 23 is obliquely arranged towards the lower cavity 10 through the through hole 113.

In this embodiment, the palm base 1 has a hollow frame structure, the back-side housing 5 corresponds to the back of the human hand, and the palm-side housing 4 corresponds to the palm of the human hand. The back-side housing 5 and the palm-side housing 4 are respectively covered on the inner and outer sides of the palm base 1, providing a relatively enclosed installation space for the base 21, the driver 23, and other components of the mechanical hand 100. This shields against adverse external interference and protects internal precision components from damage during operations of the mechanical hand 100. Moreover, a structure formed by connecting the palm-side housing 4 and the back-side housing 5 with the palm base 1 simulates a shape of a human palm, giving the mechanical hand 100 an appearance closer to that of a real hand, enabling the mechanical hand 100 to better adapt to more daily operation tasks and be suitable for applications in the medical field.

In this embodiment, the driver 23 is a small motor. An end of the motor away from the base 21, i.e., a tail of the motor, passes through the through hole 113 and is oriented obliquely toward the lower cavity 10. This configuration concentrates most of volume of the motor in the lower cavity 10, i.e., on a palm side of the human hand, effectively preventing the tail of the motor from tilting upward and interfering with other structures, thereby contributing to reducing an overall thickness of the mechanical hand 100. In many application scenarios, such as service robots and medical rehabilitation equipment, there are relatively strict requirements on an external dimensions of the mechanical hand 100. A thinner mechanical hand 100 is more aesthetic in appearance and can bring better visual experience and user feel. When the human hand moves naturally, movement of finger joints is not completely horizontal or vertical but follows a certain inclination angle and curves. Installing the motor obliquely downward can make finger movement of the mechanical hand 100 closer to kinematics characteristics of the human hand, which is more in line with the ergonomic principle, resulting in more natural and fluid performance in human-machine cooperation or scenarios that simulate movement of the human hand.

In this embodiment, the motor is obliquely installed downward at an inclination angle of 3^{o}. In some other embodiments, the inclination angle can also be adjusted according to specific requirements and an overall layout of the mechanical hand 100.

Further, a clamping part 51 is provided at an end of the back-side housing 5 close to the opening 111, a groove 211 adapted to the clamping part 51 is provided in the base 21, a clamping block 511 is formed on the clamping part 51 and extends towards the groove 211, and a clamping slot 2111 matched with the clamping block 511 is provided in the groove 211.

The clamping part 51 of the back-side housing 5 is cooperated with the groove 211 in the base 21, allowing for the back-side housing 5 to be connected with the base 21 on the palm base 1 when the back-side housing 5 is assembled on the palm base 1, enabling a more compact and stable overall structure. This facilitates uniform transferring and distribution of forces in the whole mechanical hand 100, thus improving load-bearing capacity and durability of the whole mechanical hand 100.

The clamping part 51 on the back-side housing 5 is designed as a protruding structure, and the base 21 is correspondingly provided with a groove 211 for accommodating the clamping part 51. The clamping block 511 is formed on the clamping part 51 and extends towards the groove 211, and the clamping groove 2111 matched with the clamping block 511 is defined in the groove 211. This double-clamping structure greatly enhances connection stability between the back-side housing 5 and the base 21. Cooperation between the protruding clamping part 51 and the groove 211 first provides preliminary positioning and foundational connection between the back-side housing 5 and the base 21, preventing relative displacement of the back-side housing 5 and the base 21 in the horizontal direction. Cooperation between the clamping block 511 and the clamping groove 2111 further strengthens connection strength between the back-side housing 5 and the base 21. In addition, the protruded clamping part 51 is fitted into the groove 211 in the base 21, and engagement between the clamping block 511 and the clamping groove 2111 remains hidden, contributing to a more aesthetically pleasing appearance of the mechanical hand 100, and ensuring a smooth and natural transition between the back-side housing 5 and the base 21 without abrupt gaps or irregular seams, thus improving overall fluidity of the mechanical hand 100. Compared to conventional screw connection, this connection method not only offers reliability but also simplifies the assembly process, avoiding potential issues such as misalignment during installation that would affect performance.

Further, a partition plate 13 is provided between two adjacent mounting positions 7, with a protrusion 131 extending laterally on the partition plate 13. A hooking part 52 matched with the protrusion 131 is provided on the back-side housing 5. The back-side housing 5, facing the palm base 1, is provided with a support bar 53 abutted against an outer side wall of the driver 23.

The partition plate 13 is arranged between two adjacent mounting positions 7, serving to connect the palm base 1 and the back-side housing 5. The provision of a plurality of partition plates 13 reinforce the connection. In addition, the partition plates 13 can prevent mutual interference between different drivers 23 in neighboring mounting positions 7.

The protrusion 131 extending laterally on the partition plate 13 can be clamped into the hooking part 52 on the back-side housing 5 to realize connection between the back-side housing 5 and the palm base 1. This connection method makes assembly and disassembly between the palm base 1 and the back-side housing 5 simple and quick, contributing to improved production efficiency. Additionally, an elastic clamping structure formed by the hooking part 52 and the protrusion 131 can effectively withstand external forces applied to the palm base 1, preventing loosening or detachment between the back-side housing 5 and the palm base 1.

The support bar 53 of the back-side housing 5 arranged towards the palm base 1 is abutted against the outer side wall of the driver 23, providing additional protection for the driver 23. During operations of the mechanical hand 100, the driver 23 may be subjected to external forces from various directions or experience self-induced vibrations, and the support bar 53 serves to establish a close contact between the driver 23 and the back-side housing 5, filling any potential gaps between them and offering cushioning and supporting. In addition, in this embodiment, the driver 23 is a compact motor, and the support bar 53 is defined with an arc-shaped opening for fitting against on a side wall of the motor, thus providing accurate positioning for the installation of the driver 23 and further improving installation stability of the driver 23.

Further, the base 21 is further defined with two limiting end faces 212 abutted against the two extension parts 12, and the two limiting end faces 212 are arranged at two ends of the groove 211.

The extension part 12 itself provides guidance for installation of the base 21. The limiting end faces 212 formed on the base 21 abut against the extension parts 12, which can also creates a stopping effect for the installation of the base 21. During assembly of the finger assembly 2, the base 21 needs to be inserted into the opening 111. When the limiting end face 212 on the base 21 is abutted against the extension part 12, it indicates that the installation is in place. The extension part 12 is located outside the mounting groove 11. This visual design is convenient for the operator to directly determine whether the base 21 has been assembled, to identify and correct assembly errors in time, thereby to improving assembly efficiency.

In this embodiment, while the extension part 12 is abutted against the limiting end face 212 on the base 21, the extension part 12, the base 21, and the back-side housing 5 interlock with one another, creating a natural and smooth transition at the joints among them at a surface of the mechanical hand 100. Operators can easily determine whether the base 21 is installed in place and whether its alignment with the extension part 12 and the back-side housing 5 is correct according to the external appearance of the mechanical hand 100.

Further, a protruding part 213 is provided at an end of the base 21 away from the knuckles 22, a concave slot 114 matched with the protruding part 213 is defined in the mounting groove 11, and a mounting hole 1141 penetrating through the mounting groove 11 and communicated with the outside is provided in the concave slot 114.

The connecting assembly 8 includes a fastener 6, and the fastener 6 passes through the mounting hole 1141 and penetrates through the protruding part 213.

The protruding part 213 can be accurately embedded in the concave slot 114, and the fastener 6 passes through the mounting hole 1141 and penetrates through the protruding part 213, so as to firmly fix the protruding part 213 in the mounting groove 11. This ensures that the base 21 remains in a correct position, providing positioning and limiting displacement of the finger assembly 2. This further prevents potential issues such as inaccurate movement of the finger assembly 2 or uneven force transmission caused by deviation in the mounting position, so that overall assembly accuracy of the mechanical hand 100 is improved.

In some embodiments, the fastener 6 may be a screw. The assembly process using the screws as the fastener 6 is relatively simple and intuitive. During installation of the finger assembly 2, once the protruding part 213 is properly engaged with the concave slot 114, fixation can be completed by driving the screw into the mounting hole 1141. Using standard screws can also reduce production cost, facilitate replacement of different types of screws or finger assemblies 2, thereby improving compatibility of the mechanical hand 100.

Further, a limiting part 115 is formed in the mounting groove 11 along an assembly direction of the base 21, and the base 21 is provided with a first stop part 214 which can be abutted against the limiting part 115.

The limiting part 115 is formed in the mounting groove 11 in an insertion direction of the finger assembly 2, while the base 21 is provided with the first stop part 214. When the finger assembly 2 is properly assembled, the limiting part 115 and the first stop part 214 can be abutted against each other, so as to ensure that the finger assembly 2 is accurately installed in a predetermined position. This not only ensures assembly accuracy of the mechanical hand 100, but also improves assembly speed and production quality and efficiency. When the mechanical hand 100 performs grasping and transporting, the finger assembly 2 may be subjected to various forces, and the tight contact between the limiting part 115 and the first stopping part 214 effectively prevents the finger assembly 2 from shifting during operation.

Further, the base 21 is further provided with a second stop part 215 which can be abutted against an outer side wall of the palm base 1. The first stop part 214 and the second stop part 215 are sequentially arranged along the assembly direction of the base 21, and sections of the first stop part 214 and the second stop part 215 along the assembly direction of the base 21 are stepped. When assembled in place, the first stop part 214 is located in the mounting groove 11, and the second stop part 215 is located outside the mounting groove 11.

The coordinated configuration of the first stop part 214 and the second stop part 215 can realize dual accurate positioning of the finger assembly 2 in the insertion direction. The second stop part 215 is abutted against the outer side wall of the palm base 1 and is located outside the mounting groove 11 when it is properly engaged , which is convenient for the operator to visually confirm whether the insertion position of the finger assembly 2 is correct. The first stop part 214 is located in the mounting groove 11 when it is properly engaged, serving to determine a final insertion position of the finger assembly 2 and prevent the finger assembly 2 from being excessively inserted into the mounting groove 11. This further ensures precise positioning of the finger assembly 2 during installation, thereby improving the assembly accuracy.

Sections of the first stop part 214 and the second stop part 215 along the insertion direction of the finger assembly 2 are stepped, so that the second stop part 215 is cleverly blocked by the palm base 1 outside the mounting groove 11. In addition, when the finger assembly 2 is subjected to an external force, the stepped configuration of the first stop part 214 and the second stop part 215 enables a gradual absorption of force during transmission of the force. This segmented buffering mechanism can effectively reduce impact forces to the finger assembly 2 and the palm base 1, thereby prolonging the service life of the mechanical hand 100.

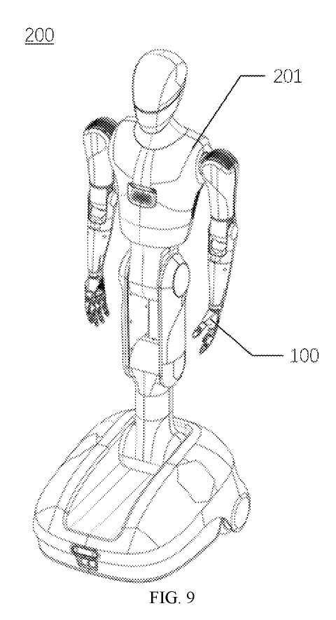

Referring to FIG. 9, a robot 200 is further provided in the present disclosure, which includes a robot body 201 and a mechanical hand 100 provided on the robot body 201. The mechanical hand 100 is the mechanical hand 100 described above.

The above is only a part or preferred embodiments of the disclosure, and neither the text nor the figures can serve to limit the protection scope of the disclosure. Any equivalent structural transformation made under a concept integral with the disclosure using the specification and drawings of the present disclosure, which is directly or indirectly applied to other related technical fields, is included within the protection scope of the disclosure.

What is claimed is:

1. A mechanical hand, comprising:
a palm base; and
a plurality of finger assemblies, each of the finger assemblies comprising a base, knuckles mounted on the base, and a driver for driving the knuckles to rotate relative to the base, one end of the driver being fixed on the base and the other end of the driver extending away from the knuckles;
wherein the palm base is defined with a mounting groove, the mounting groove has an opening communicated with outside, and an end of the mounting groove away from the opening is provided with a mounting position; the driver enters the mounting position through the opening, and the base is at least partially accommodated in the mounting groove; a side of the mounting groove close to the opening is formed with an arc-shaped end face gradually tapered from inside to outside for limiting a horizontal movement range of the base;
the mechanical hand further comprises a connecting assembly for fixing the base in the mounting groove; and
the arc-shaped end face is a U-shaped end face, and both ends of the arc-shaped end face are further formed with extension parts extending towards the knuckles.

2. The mechanical hand according to claim 1, further comprising a palm-side housing and a back-side housing respectively covering inner and outer sides of the palm base, wherein an upper cavity is defined between the back-side housing and the palm base, a lower cavity is defined between the palm-side housing and the palm base, and a through hole communicating the upper cavity with the lower cavity is defined in the mounting position; and the driver is located in the upper cavity, and the driver is obliquely arranged towards the lower cavity via the through hole.

3. The mechanical hand according to claim 2, wherein a clamping part is provided at an end of the back-side housing close to the opening, the base is defined with a groove adapted to the clamping part, a clamping block is formed on the clamping part and extends towards the groove, and a clamping slot matched with the clamping block is provided in the groove.

4. The mechanical hand according to claim 3, wherein a partition plate is provided between two adjacent mounting positions, a protrusion extending transversely is provided on the partition plate, and a hooking part matched with the protrusion is provided on the back-side housing; and the back-side housing is provided with a support bar towards the palm base and abutted against an outer side wall of the driver.

5. The mechanical hand according to claim 3, wherein the base is further provided with two limiting end faces abutted against the two extension parts, and the two limiting end faces are arranged at two ends of the groove.

6. The mechanical hand according to claim 1, wherein a protruding part is provided at an end of the base away from the knuckles, and a concave slot matched with the protruding part is defined in the mounting groove, and a mounting hole penetrating through the mounting groove and communicated with the outside is provided in the concave slot; and
the connecting assembly comprises a fastener, and the fastener passes through the mounting hole and penetrates through the protruding part.

7. The mechanical hand according to claim 6, wherein a limiting part is formed in the mounting groove along an assembly direction of the base, and the base is provided with a first stop part capable of abutting against the limiting part.

8. The mechanical hand according to claim 7, wherein the base is further provided with a second stop part capable of abutting against an outer side wall of the palm base; the first stop part and the second stop part are sequentially arranged along the assembly direction of the base, and sections of the first stop part and the second stop part along the assembly direction of the base are stepped; and when assembled in place, the first stop part is located in the mounting groove, and the second stop part is located outside the mounting groove.

9. A robot, comprising a robot body and a mechanical hand arranged on the robot body, wherein the mechanical hand is the mechanical hand according to claim 1.

10. The robot according to claim 9, wherein the mechanical hand further comprises a palm-side housing and a back-side housing respectively covering inner and outer sides of the palm base, an upper cavity is defined between the back-side housing and the palm base, a lower cavity is defined between the palm-side housing and the palm base, and a through hole communicating the upper cavity with the lower cavity is defined in the mounting position; and the driver is located in the upper cavity, and the driver is obliquely arranged towards the lower cavity via the through hole.

11. The robot according to claim 10, wherein a clamping part is provided at an end of the back-side housing close to the opening, the base is defined with a groove adapted to the clamping part, a clamping block is formed on the clamping part and extends towards the groove, and a clamping slot matched with the clamping block is provided in the groove.

12. The robot according to claim 11, wherein a partition plate is provided between two adjacent mounting positions, a protrusion extending transversely is provided on the partition plate, and a hooking part matched with the protrusion is provided on the back-side housing; and the back-side housing is provided with a support bar towards the palm base and abutted against an outer side wall of the driver.

13. The robot according to claim 11, wherein the base is further provided with two limiting end faces abutted against the two extension parts, and the two limiting end faces are arranged at two ends of the groove.

14. The robot according to claim 9, wherein a protruding part is provided at an end of the base away from the knuckles, and a concave slot matched with the protruding part is defined in the mounting groove, and a mounting hole penetrating through the mounting groove and communicated with the outside is provided in the concave slot; and
the connecting assembly comprises a fastener, and the fastener passes through the mounting hole and penetrates through the protruding part.

15. The robot according to claim 14, wherein a limiting part is formed in the mounting groove along an assembly direction of the base, and the base is provided with a first stop part capable of abutting against the limiting part.

16. The robot according to claim 15, wherein the base is further provided with a second stop part capable of abutting against an outer side wall of the palm base; the first stop part and the second stop part are sequentially arranged along the assembly direction of the base, and sections of the first stop part and the second stop part along the assembly direction of the base are stepped; and when assembled in place, the first stop part is located in the mounting groove, and the second stop part is located outside the mounting groove.
